(19) United States
(12) Patent Application Publication
(10) Pub. No.: US 2017/0169126 A1
(43) Pub. Date: Jun. 15, 2017

(54) METHOD AND DEVICE OF DISPLAYING WEBPAGE

(71) Applicant: GUANGZHOU UCWEB COMPUTER TECHNOLOGY CO., LTD., GUANGZHOU (CN)

(72) Inventor: XIAOZHEN WANG, GUANGZHOU (CN)

(21) Appl. No.: 15/442,455

(22) Filed: Feb. 24, 2017

Related U.S. Application Data
(63) Continuation of application No. PCT/CN2015/076974, filed on Apr. 20, 2015.

(51) Int. Cl. G06F 17/30; G06F 17/27; G06F 17/22; G06F 17/21

(52) U.S. Cl. CPC G06F 17/30905; G06F 17/218; G06F 17/2705; G06F 17/2247; G06F 17/227; G06F 17/30861; G09G 2340/145

(57) ABSTRACT

Techniques pertaining to a webpage display are disclosed. According to one aspect of the present invention, a method of displaying a webpage comprises parsing a plurality of elements of a webpage successively until recognizing a first screen element, which is defined for a first screen of the webpage, and displaying the first screen of the webpage based on the plurality of elements previously parsed. Thus, the screen of the webpage is displayed without any delay.

### CROSS-REFERENCE TO RELATED APPLICATION

This application is a continuation application of International Application No. PCT/CN2015/076974, filed on Apr. 20, 2015, the entire content of which is incorporated herein by reference.

### FIELD

The present invention relates to the technical field of webpage display, and in particular, to a method, and a device for displaying a first screen of a webpage.

### BACKGROUND

With the advent of the 4G era, accessing the Internet for information by mobile phone browsers becomes a mainstream way. The advantage of using the mobile phone browser is that people can use pieces of time to browse Internet pages at any time and any place. This advantage can be achieved by the increase of the speed of mobile networks, and the enhancement of the performance of the mobile hardware. It also requires a higher display speed of the webpage on the mobile phone. According to statistics, the time to open a webpage that satisfies users most is equal to or less than 2 seconds; users can endure about 6 to 8 seconds to open a large webpage; and most users will give up access the webpage if the webpage open time is more than 8 seconds.

In a mobile browser, users may be mainly concerned about two time points of a webpage display. The first time point is for a first webpage display. At this time point, only a small portion of the content of a webpage, such as title text of the webpage, is displayed. The second time point is for a full content display as the webpage is filled in the entire screen for the first time and the second time point is also referred as an open time of a first screen. The open time of the first screen that satisfies users is equal to or less than 2 seconds usually. Thus, if the mobile browser can speed up page display of the first screen, a better experience may be brought to users.

Therefore, improved techniques for accelerating display of a webpage are desired to enhance users' experience.

### SUMMARY

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In general, the present invention is directed to a method, and a device for displaying a first screen of a webpage without any delay.

According to one aspect of the present invention, a method of displaying a webpage is provided, and the method comprises: parsing a plurality of elements of a webpage successively until recognizing a first screen element, which is defined for a first screen of the webpage; and displaying the first screen of the webpage based on the plurality of elements previously parsed.

According to another aspect of the present invention, a device of displaying a webpage is provided, and the device comprises: a layout engine configured for parsing a plurality of elements of a webpage successively until recognizing a first screen element, which is defined for a first screen of the webpage; and a displaying module configured for displaying the first screen of the webpage based on the plurality of elements previously parsed.

One of the features, benefits and advantages in the present invention is to provide techniques for displaying the first screen of the webpage timely to shorten the display time of the first screen.

Other objects, features, and advantages of the present invention will become apparent upon examining the following detailed description of an embodiment thereof, taken in conjunction with the attached drawings.

### BRIEF DESCRIPTION OF THE DRAWINGS

Various objects and advantages and a more complete understanding of the present invention are apparent and more readily appreciated by referring to the following detailed description and to the appended claims when taken in conjunction with the accompanying drawings:

FIG. 1 illustrates a block diagram showing a system according to one embodiment of the present invention;

FIG. 2a illustrates an internal functional block diagram showing a portable device according to one embodiment of the present invention;

FIG. 2b illustrates a functional block diagram showing a browser according to one embodiment of the present invention;

FIG. 3 illustrates a flowchart 300 showing a method of displaying a webpage according to one embodiment of the present invention;

FIG. 4a illustrates a schematic diagram showing an example of displaying a webpage in conventional manner;

FIG. 4b illustrates a schematic diagram showing an example of displaying a webpage in the present invention;

FIG. 5a illustrates a schematic diagram showing an example of a webpage, wherein three first screen elements are marked for three different screen sizes; and

FIGS. 5b, 5c and 5d illustrate the first screen of the webpage in FIG. 5a displayed on the client devices with the three different screen-sizes, respectively.

### DETAILED DESCRIPTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

While the present invention is described herein with references to illustrative embodiments for particular applications, it should be understood that the invention is not limited thereto. Those skilled in the art with access to the teachings herein will recognize additional modifications, applications, and embodiments within the scope thereof and additional fields in which the invention would be of significant utility.

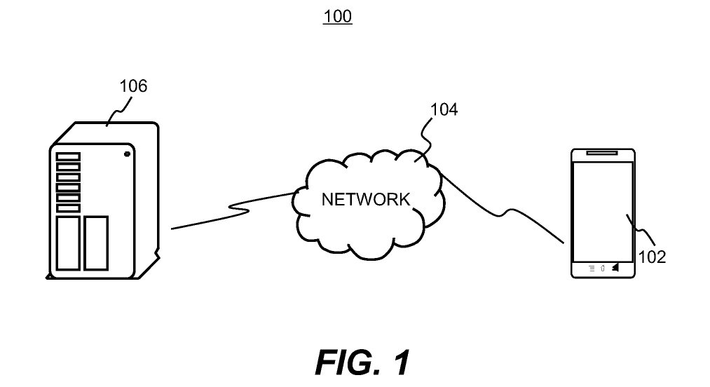

Embodiments of the present invention are disclosed herein with reference to FIGS. 1-5a-5d. However, those skilled in the art will readily appreciate that the detailed description given herein with respect to these figures is for explanatory purposes as the invention extends beyond these limited embodiments.

FIG. 1 illustrates a block diagram of a system 100 according to one embodiment of the present invention. Referring to FIG. 1, the system 100 comprises a client device 102, a network 104, and a web server 106. A webpage corresponding to a web address is uploaded onto the web server 106. The client device 102 may be a portable device or mobile device which can access the webpage on the web server 106 via the network 104.

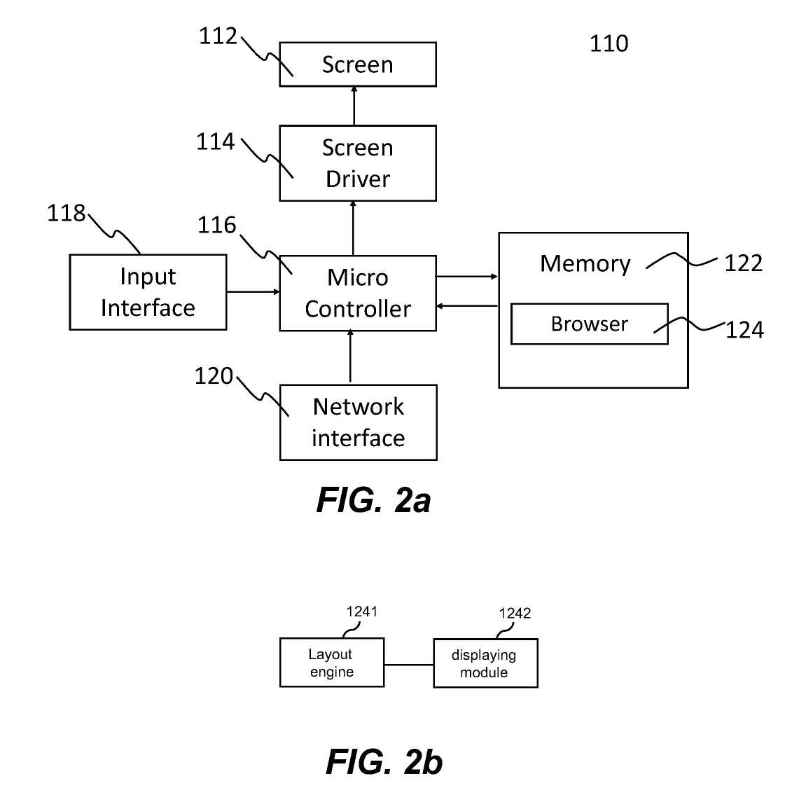

FIG. 2a illustrates an internal functional block diagram 110 of the portable device that may correspond to the client device 102 of FIG. 1. Referring to FIG. 2, the portable device 110 comprises a micro controller 116, an input interface 118, a screen driver 114, a screen 112, a network interface 120 and a memory 122. The screen 112 may be a touch screen (e.g., LCD or OLED). The screen 112 communicates with and is commanded by a screen driver 114 that is controlled by a microcontroller (e.g., a processor) 116. The memory 122 may be loaded with a browser 124 that can be executed by the microcontroller 116 to browse the webpage on the web server 106. The portable device 110 further includes a network interface 120. The network interface 120 is provided to enable the portable device 110 to communicate with other devices through a data network (e.g., the Internet or LAN).

In one embodiment, the browser 124 is designed to perform a set of functions that are to be described further herein. The browser 124 may be implemented in software according to one embodiment of the present invention. A general portable device would not perform the functions or results desired in the present invention unless it is installed with the browser which is driven in a way specified herein.

FIG. 2b illustrates a functional block diagram showing a browser 124 according to one embodiment of the present invention. Referring to FIG. 2b, the browser 124 can receive a request to load and display a webpage, and can also parse and display a webpage by a request. The browser 124 comprises a layout engine 1241 to parse the data resource of a webpage requested from the server 106 and construct a document object model (DOM) tree which is configured to be rendered. Then a rendering tree corresponding to the DOM tree can be displayed by a display module 1242.

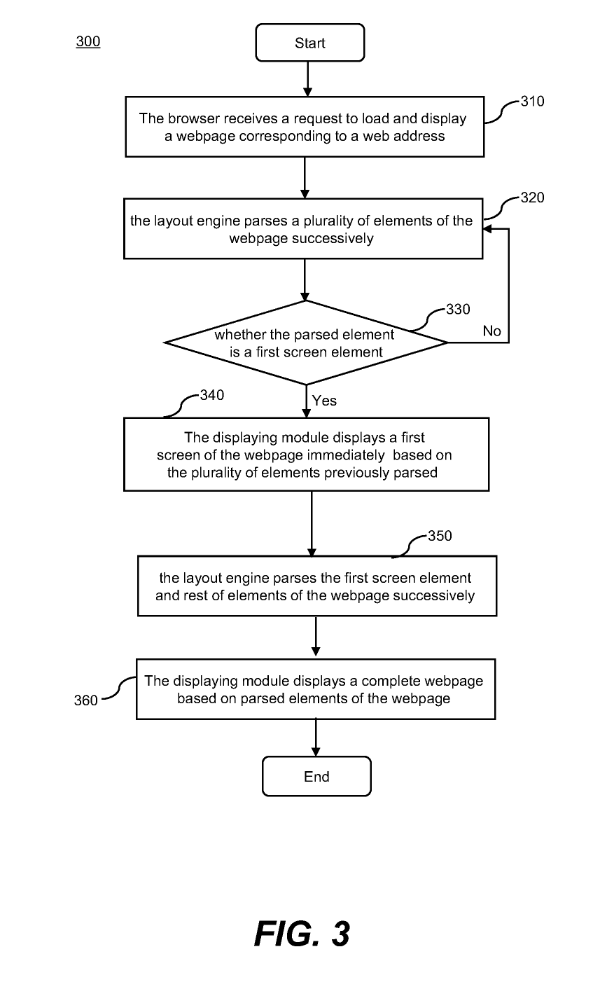

FIG. 3 illustrates a flowchart 300 showing a method of displaying a webpage according to a first embodiment of the present invention. Referring to FIG. 3, at the step 310, the browser receives a request to access a webpage corresponding to a web address.

The webpage is designed and uploaded onto the web server 106 in advance. The webpage is displayed by a plurality of elements (Html elements). In order to display a first screen of the webpage quickly, the first screen of the webpage merely includes a part of the elements of the webpage that can fill with the display screen for the first time. A webpage developer may be used for marking one element referred as a first screen element, which is defined for the first screen of the webpage by a developer tool such as Chrome's Developer Tools.

At the step 320, the layout engine 1241 parses a plurality of elements of the webpage. Then, the method 300 goes to the step 330, where whether the parsed element is the first screen element is determined. If the parsed element is not the first screen element, the method 300 returns to the step 320 to continue parsing the elements of the webpage. If the parsed element is the first screen element, the method 300 goes to the step 340, where the display module 1242 displays the first screen of the webpage based on the plurality of elements previously parsed. Thus, the first screen is displayed without any delay.

At the step 350, the layout engine 1241 continues to parse the first screen element and the rest of the elements of the webpage successively.

At the step 360, the display module 1242 further displays a complete webpage based on the parsed elements of the webpage.

As described above, the layout engine 1241 parses the elements of the webpage successively until the first screen element is recognized. The display module 1242 displays the first screen of the webpage based on the plurality of elements previously parsed timely once the first screen element is obtained. In other words, the layout engine 1241 stops parsing and rendering the element of the webpage to display the first screen of the webpage when the first screen element is obtained. Because the webpage developer may select a suitable element as the first screen element for the screen-size of the client device used to display the webpage, the browser may parse the elements of the webpage successively and proceed to display the first screen at a satisfying first time point. Thus, the display time of the first screen is shortened in the present invention.

The first screen element is determined through a mark which is set during developing the webpage by the webpage developer.

In the first embodiment, only one element is marked as the first screen element according to a fixed screen-size of the client device used to display the webpage. Namely, the mark is configured to define one first screen element. Depending on implementation, the mark is set as a CSS (Cascading Style Sheet) attribute which includes a syntax element referred as “first screen paint” and directly marks one element as the first screen element inner/outer linked in the element. The CSS attribute is obtained during parsing the plurality of elements of the webpage. If the “first screen paint” of the parsed element is equal to “YES”, the parsed element is determined to be the first screen element; otherwise, the parsed element is determined not to be the first screen element.

However, the conventional client devices such as mobile phones have multiple screen-sizes, such as 4-inch screen, 5-inch screen, 5.5-inch screen etc., and the areas of the first screens for the mobile devices with different screen sizes are different. For better display effect, the first screen element should be changed with the screen-size of the client device used to display the webpage. In the second embodiment, a plurality of elements of the webpage are marked as the first screen elements according to multiple screen-sizes of the client device. Namely, the mark is configured to define one first screen element to adapt multiple screen-sizes of the client device. Depending on implementation, the mark is set as a CSS media query which may be configured into a header of the webpage including a syntax element referred as “first screen paint” to define IDs (Identifier) of the plurality of first screen elements. The CSS media query is obtained during parsing the header of the webpage.

After the IDs of the first screen elements are obtained during parsing the header of the webpage, one ID of the first screen elements suitable for a client device used to display the webpage is selected according to the screen-size of the device used to display the webpage. Then, the ID of the parsed element is compared with the ID of the selected first screen element. If yes, the parsed element is determined to be the first screen element; otherwise, the parsed element is determined not to be the first screen element. Because one of the first screen elements of the webpage most suitable for the screen-size of the client device using to display the webpage is selected, all the client devices with different screen-sizes can display the first screen of the webpage quickly.

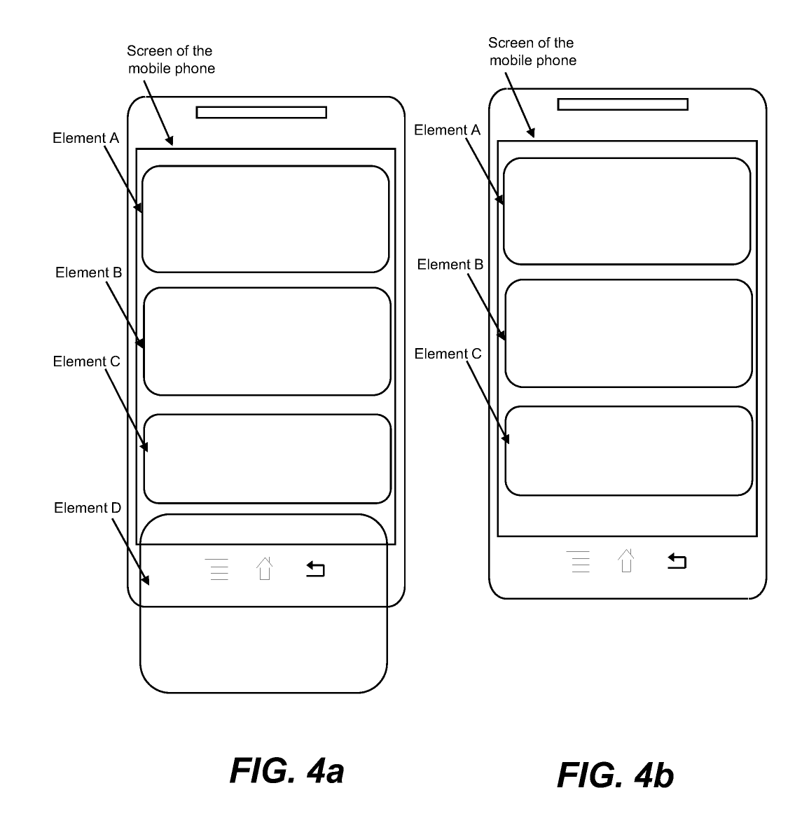

FIG. 4a is a schematic diagram showing an example of displaying a webpage on a mobile phone in a conventional manner. FIG. 4b is a schematic diagram showing an example of displaying a webpage on a mobile phone in the present invention. Referring to FIGS. 4a and 4b, the webpage in the web server 106 at least includes an element A, an element B, an element C, and an element D. In the conventional manner, the element D also should be rendered to form the first screen of the webpage in order to fill the entire screen of the mobile phone. If the element D is complicate, the display of the first screen of the webpage will be delayed. Referring to FIG. 4b, the element D is marked as the first screen element, so the first screen of the webpage may be displayed when the element D is parsed and before the element D is rendered. As a result, the first screen of the webpage will be displayed quickly.

Referring to FIG. 4b, in a preferred embodiment, the first screen element will not be displayed into the first screen of the webpage. In other words, the first screen element is not the element in the first screen of the webpage, and will be parsed and displayed after the first screen of the webpage has been displayed.

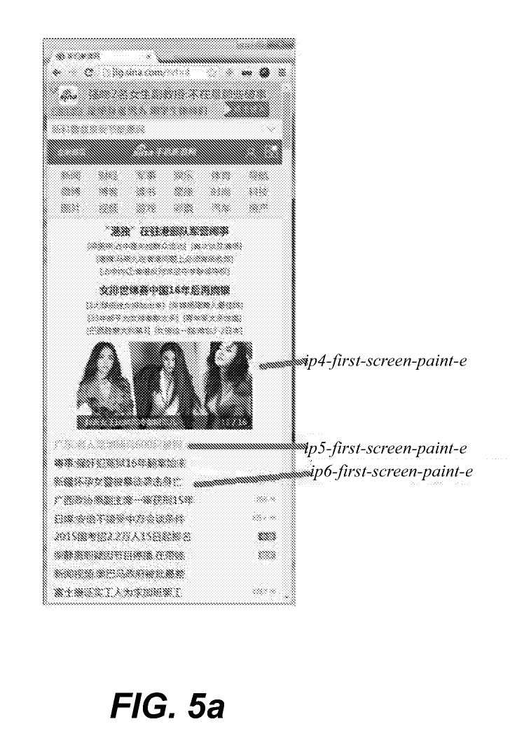

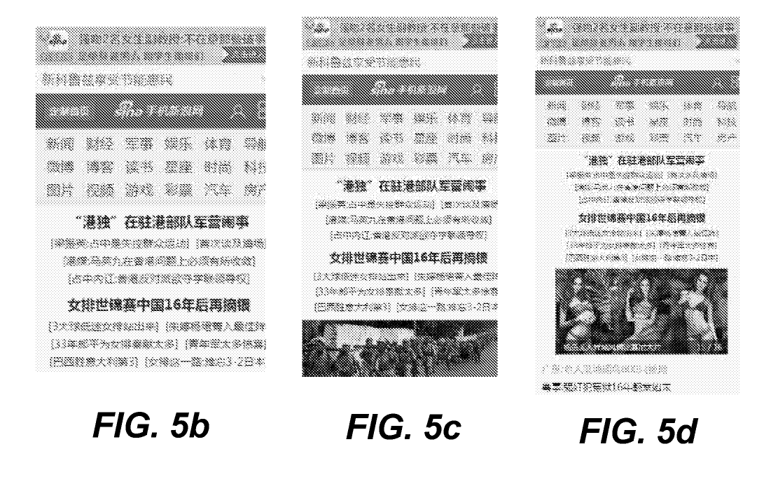

FIG. 5a is a schematic diagram showing an example of a webpage, wherein three first screen elements ip4-first-screen-paint-e, ip5-first-screen-paint-e, ip6-first-screen-paint-e are marked for three different screen-sizes of a client device. The first screen element ip4-first-screen-paint-e is for the first screen-size which has a device aspect ratio: 320/480 and a device pixel ratio: 2, such as the screen-size of iphone4. The first screen element ip5-first-screen-paint-e is for the second screen-size, which has a device aspect ratio: 320/568 and a device pixel ratio: 2, such as the screen size of the iphone5. The first screen element ip6-first-screen-paint-e is for the screen-size, which has a device aspect ratio: 414/736 and a device pixel ratio: 3, such as the screen size of the iphone6. Wherein, ip5-first-screen-paint-e, ip4-first-screen-paint-e and ip6-first-screen-paint-e are the IDs of the first screen elements. The webpage shown in FIG. 5a can support the quickly display of the first screen on the client device with the three screen-sizes.

FIG. 5b is an exemplary diagram showing the first screen of the webpage shown in FIG. 5a displayed on the client device with the first screen-size; FIG. 5c is an exemplary diagram showing the first screen of the webpage shown in FIG. 5a displayed on the client device with the second screen-size; FIG. 5d is an exemplary diagram showing the first screen of the webpage shown in FIG. 5a displayed on the client device with the third screen-size.

For example, the following web code will be added into the CSS media queries of the webpage in order to display of the first screen of the webpage quickly:

```
/* for iphone4 */
@media screen and (device-aspect-ratio:320/480)
and (device-pixel-ratio:2) {
  #ip4-first-screen-paint-e {
    first-screen-paint: yes
  }
}
/* for iphone5 */
@media screen and (device-aspect-ratio:320/568)
and (device-pixel-ratio:2) {
  #ip5-first-screen-paint-e {
    first-screen-paint: yes
  }
}
/* for iphone6 */
@media screen and (device-aspect-ratio:414/736)
and (device-pixel-ratio:3) {
  #ip6-first-screen-paint-e {
    first-screen-paint: yes
  }
}
```

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method of displaying a webpage, comprising:
parsing a plurality of elements of a webpage successively until recognizing a first screen element, which is defined for a first screen of the webpage; and
displaying the first screen of the webpage based on the plurality of elements previously parsed.

2. The method according to claim 1, further comprising:
parsing the first screen element and rest of the elements of the webpage successively; and
displaying a complete webpage based on parsed elements of the webpage.

3. The method according to claim 1, wherein the first screen element is recognized through a mark which is configured to define at least one first screen element.

4. The method according to claim 3, wherein the mark is obtained during parsing a header of the webpage.

5. The method according to claim 3, wherein the mark is obtained during parsing the plurality of the elements of the webpage.

6. The method according to claim 3, wherein the mark is set as a Cascading Style Sheet (CSS) attribute added into the first screen element, or the mark is set as a CSS media query which is configured into the header of the webpage.

7. The method according to claim 3, wherein the mark is configured to define one first screen element according to a screen-size of a device using to display the webpage.

8. The method according to claim 3, wherein the mark is configured to define a plurality of first screen elements to adapt multiple screen-sizes.

9. The method according to claim 8, wherein one of the first screen elements suitable for a device used to display the webpage is determined according to the screen-size of the device during parsing a header of the webpage.

10. A device of displaying a webpage, comprising:
a layout engine configured to parse a plurality of elements of a webpage successively until recognizing a first screen element, which is defined for a first screen of the webpage; and
a displaying module configured to display the first screen of the webpage based on the plurality of elements previously parsed.

11. The device according to claim 9, wherein
the layout engine is further configured to parse the first screen element and the rest of the elements of the webpage successively; and
the display module is further configured to display a complete webpage based on parsed elements of the webpage.

12. The device according to claim 10, wherein the first screen element is recognized through a mark which is configured to determine at least one first screen element.

13. The device according to claim 12, wherein the mark is obtained during parsing a header of the webpage.

14. The device according to claim 12, wherein the mark is obtained during parsing the plurality of elements of the webpage.

15. The device according to claim 12, wherein the mark is set as a CSS attribute added into the first screen element, or the mark is set as a CSS media query which is configured into the header of the webpage.

16. The device according to claim 12, wherein the mark is configured to determine one first screen element according to a screen-size of a device used to display the webpage.

17. The device according to claim 12, wherein the mark is configured to define a plurality of first screen elements to adapt multiple screen-sizes.

18. The device according to claim 17, wherein one of the first screen elements suitable for a device used to display the webpage is determined according to the screen-size of the device during parsing a header of the webpage.
